(19) United States
(12) Patent Application Publication
(10) Pub. No.: US 2026/0238923 A1
(43) Pub. Date: Aug. 13, 2026

(54) AUDIO SIGNAL DECORRELATOR STRUCTURE FOR RENDERING SOURCE EXTENT

(71) Applicant: FRAUNHOFER-GESELLSCHAFT ZUR FOERDERUNG DER ANGEWANDTEN FORSCHUNG E.V., Muenchen (DE)

(72) Inventors: Sascha DISCH, Erlangen (DE); Juergen HERRE, Erlangen (DE); Matthias GEIER, Erlangen (DE); Vensan MAZMANYAN, Erlangen (DE)

(21) Appl. No.: 19/639,931

(22) Filed: Apr. 6, 2026

Related U.S. Application Data
(63) Continuation of application No. PCT/EP2024/078259, filed on Oct. 8, 2024.

(30) Foreign Application Priority Data
Oct. 9, 2023 (EP) 23202425.7

(51) Int. Cl. H04R 5/04; G10L 21/16

(52) U.S. Cl. CPC H04R 5/04; G10L 21/16; H04R 2420/01

(57) ABSTRACT

An apparatus for processing a first audio signal to generate two or more second audio signals according to an embodiment is provided. The apparatus comprises a decorrelation module configured for generating two or more processed signals from the first audio signal. The decorrelation module is configured to generate each processed signal of the two or more processed signals by transforming the first audio signal to a frequency domain to obtain a transformed audio signal, by applying a delay, by applying allpass filters on the transformed audio signal, by conducting envelope shaping and by conducting an inverse transform to obtain the processed signal. Moreover, the apparatus comprises a mixer.

### CROSS-REFERENCE TO RELATED APPLICATIONS

This application is a continuation of copending International Application No. PCT/EP2024/078259, filed Oct. 8, 2024, which is incorporated herein by reference in its entirety, and additionally claims priority from European Application No. EP EP23202425.7, filed Oct. 9, 2023, which is also incorporated herein by reference in its entirety.

The present invention relates to audio signal processing, and, in particular, to an apparatus and a method exhibiting or using an audio signal decorrelator structure for rendering source extent.

### BACKGROUND OF THE INVENTION

As an alternative to rendering and binauralizing the output to headphones, the playback over loudspeakers is specified. In this operation mode, the binaural spatializer (HRTF based renderer) is replaced with a dedicated loudspeaker-based renderer.

For a high quality listening experience, loudspeaker setups assume the listener to be situated in a dedicated fixed location, the so-called sweep spot. Typically, within a 6 DOF playback situation, the listener is moving. Therefore, the 3D spatial rendering has to be instantly and continuously adapted to the changing listener position. This is achieved in two hierarchically nested technology levels:

Gains and delays are applied to the loudspeaker signals such that at the loudspeaker signals reach the listener position at a similar gain and delay. Optionally a high shelving compensation filter is applied to each loudspeaker signal related to the current listener position and the loudspeakers' orientation with respect to the listener. This way, as a listener moves to positions off-axis for a loudspeaker or further away from it, high frequency loss due to the loudspeaker's radiation high-frequency pattern is compensated.

Due to the 6 DoF movement, the angles between loudspeakers, objects and the listener change as a function of listener position. Therefore, the 3D amplitude panning algorithm is updated in real-time with the relative positions and angles of the varying listener position and the fixed loudspeaker configuration as set in the LSDF. All coordinates (listener position, source positions) are transformed into the listening room coordinate system.

Level 1 (Physical compensation level) realizes real-time updated compensation of loudspeaker (frequency-dependent) gain & delay enables ‘enhanced rendering of content’. By exploiting the tracked user position information, the listener can move within a large “sweet area” (rather than a sweet spot) and experience a stable sound stage in this large area when listening to legacy content (e.g. stereo, 5.1, 7.1+4H). For immersive formats (i.e., not for stereo), the sound seems to detach from the loudspeakers rather than collapse into the nearest speakers when walking away from the sweet spot, i.e. a quality somewhat close to what is known from wavefield synthesis, but for a single-user experience. For stereo reproduction, the technology offers left-right sound stage stability for a wide range of user positions (i.e. the range between the left and right loudspeakers at arbitrary distance).

Level 2 (Object rendering level) realizes user-tracked object panning enables rendering of point sources (objects, channels) within the 6 DoF play space and may employ Level 1 as a prerequisite. Thus, it addresses the use case of ‘6 DoF VR/AR rendering’.

Spatially Extended Sound Sources (SESS) with a perceptual property of “Source Extent” can be modelled and reproduced via loudspeaker by a number of so-called helper point sources that are distributed in a VR scene geometry.

SESS may be employed in a level 3, homogeneous extent rendering level. In level 3 loudspeaker processing translates rendering a homogeneous spatially extended sound source (SESS) into rendering a set of substitute point sources. These point sources may then be further processed using Level 2. Level 3 is a level ‘on top’ of Level 2.

Prior art decorrelators and their post-processing are known from parametric spatial audio coding like parametric stereo or MPEG Surround [1, 2, 3, 4].

In [4], output signals are derived from a number of decorrelators in a tree-like structure. However, the tree topologies known from conventional technology assume a dedicated reproduction setup of loudspeakers that are placed in the reproduction room in pre-defined locations and are not suitable to feed the helper sources needed for modeling and reproduction of “Source Extent”.

For best perceptual quality, it is beneficial to adapt the decorrelation processing to transients in the signal content [5]. Other art does not allow for a transient handling in multi-output decorrelation.

### SUMMARY

According to an embodiment, an apparatus for processing a first audio signal to generate two or more second audio signals may have: a decorrelation module configured for generating two or more processed signals from the first audio signal, wherein the decorrelation module is configured to generate each processed signal of the two or more processed signals by transforming the first audio signal to a frequency domain to obtain a transformed audio signal, by applying a delay, by applying allpass filters on the transformed audio signal, by conducting envelope shaping and by conducting an inverse transform to obtain the processed signal, and a mixer configured for generating each second audio signal of the two or more second audio signals by conducting a mixing of at least two processed signals of the two or more processed signals, wherein the decorrelation module is configured to apply the allpass filters using different filter coefficients for generating each of the two or more processed signals, and wherein the mixer is configured to conduct the mixing in a different way for generating each of the two or more second audio signals.

According to another embodiment, a method for processing a first audio signal to generate two or more second audio signals may have the steps of: generating two or more processed signals from the first audio signal, wherein generating each processed signal of the two or more processed signals is conducted by transforming the first audio signal to a frequency domain to obtain a transformed audio signal, by applying a delay, by applying allpass filters on the transformed audio signal, by conducting envelope shaping and by conducting an inverse transform to obtain the processed signal, and generating each second audio signal of the two or more second audio signals by conducting a mixing of at least two processed signals of the two or more processed signals, wherein applying the allpass filters is conducted using different filter coefficients for generating each of the two or more processed signals, and wherein the mixing is conducted in a different way for generating each of the two or more second audio signals.

Another embodiment may have a non-transitory digital storage medium having a computer program stored thereon to perform the inventive method for processing a first audio signal to generate two or more second audio signals, when said computer program is run by a computer.

An apparatus for processing a first audio signal to generate two or more second audio signals according to an embodiment is provided. The apparatus comprises a decorrelation module configured for generating two or more processed signals from the first audio signal, wherein the decorrelation module is configured to generate each processed signal of the two or more processed signals by transforming the first audio signal to a frequency domain to obtain a transformed audio signal, by applying a delay, by applying allpass filters on the transformed audio signal, by conducting envelope shaping and by conducting an inverse transform to obtain the processed signal. Moreover, the apparatus comprises a mixer configured for generating each second audio signal of the two or more second audio signals by conducting a mixing of at least two processed signals of the two or more processed signals. The decorrelation module is configured to apply the allpass filter using different filter coefficients for generating each of the two or more processed signals. The mixer is configured to conduct the mixing in a different way for generating each of the two or more second audio signals.

Moreover, a method for processing a first audio signal to generate two or more second audio signals according to an embodiment is provided. The method comprises:
Generating two or more processed signals from the first audio signal, wherein generating each processed signal of the two or more processed signals is conducted by transforming the first audio signal to a frequency domain to obtain a transformed audio signal, by applying a delay, by applying allpass filters on the transformed audio signal, by conducting envelope shaping and by conducting an inverse transform to obtain the processed signal. And:
Generating each second audio signal of the two or more second audio signals by conducting a mixing of at least two processed signals of the two or more processed signals.

Furthermore, a computer program for implementing the above-described method when being executed on a computer or signal processor according to an embodiment is provided.

Applying the allpass filter is conducted using different filter coefficients for generating each of the two or more processed signals. The mixing is conducted in a different way for generating each of the two or more second audio signals.

Embodiments are directed to obtain high perceptual quality input signals to feed helper sources of spatially extended sound sources. This is achieved by the application of decorrelators to a common mono input signal and a dedicated post-mixing of the output of the decorrelators and said mono signal.

### BRIEF DESCRIPTION OF THE DRAWINGS

Embodiments of the present invention will be detailed subsequently referring to the appended drawings, in which:

FIG. 1 illustrates an apparatus for processing a first audio signal to generate two or more second audio signals according to an embodiment.

FIG. 2 illustrates a scenario where within the width (+−γ) of the extended object, five objects are equally distributed.

FIG. 3 illustrates five objects, which are rotated such that the middle object has the same azimuth and elevation as the extended object.

FIG. 4 illustrates a decorrelator tree structure according to an embodiment.

FIG. 5 illustrates an MPEG-I decorrelator according to an embodiment.

### DETAILED DESCRIPTION OF THE INVENTION

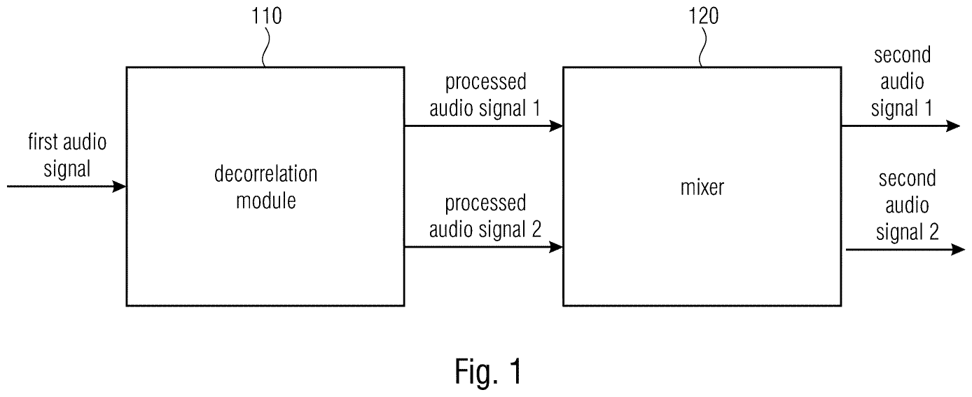

FIG. 1 illustrates an apparatus for processing a first audio signal to generate two or more second audio signals according to an embodiment.

The apparatus comprises a decorrelation module 110 configured for generating two or more processed signals from the first audio signal. The decorrelation module 110 is configured to generate each processed signal of the two or more processed signals by transforming the first audio signal to a frequency domain to obtain a transformed audio signal, by applying a delay, by applying allpass filters on the transformed audio signal, by conducting envelope shaping and by conducting an inverse transform to obtain the processed signal.

Moreover, the apparatus comprises a mixer 120 configured for generating each second audio signal of the two or more second audio signals by conducting a mixing of at least two processed signals of the two or more processed signals.

The decorrelation module 110 is configured to apply the allpass filter using different filter coefficients for generating each of the two or more processed signals.

The mixer 120 is configured to conduct the mixing in a different way for generating each of the two or more second audio signals.

According to an embodiment, the mixer 120 or the decorrelation module 110 may, e.g., be configured to generate each second audio signal of the two or more second audio signals by conducting a mixing of the at least two processed signals and of the first audio signal.

In an embodiment, the mixer 120 may, e.g., be configured to conduct the mixing of the at least two processed signals and of the first audio signal by applying a first weighting factor on the first audio signal, by applying a second weighting factor on each of the at least two processed signals and by combining the first audio signal after an application of the first weighting factor and the at least two processed signals after an application of the second weighting factor on each of the at least two processed signals.

According to an embodiment, the mixer 120 may, e.g., be configured to apply a same second weighting factor on each of the at least two processed signals.

In an embodiment, the first and/or the second weighting factor may, e.g., depend a width of a spatially extended sound source which shall be modelled.

According to an embodiment, the mixer 120 may, e.g., be configured to apply

$$\frac{180 ° - γ}{180 °} + 1$$

as the first weighting factor on the first audio signal, and wherein the mixer (120) is configured to apply

$$\frac{γ}{180 °}$$

as the second weighting factor on each of the at least two processed audio signals, wherein γ is an angular value which depends on the width of the spatially extended sound source, which shall be modeled.

In an embodiment, the decorrelation module 110 may, e.g., be configured to generate three or more processed signals. The mixer 120 may, e.g., be configured for generate at least one second audio signal of the two or more second audio signals by conducting a mixing of at least three processed signals of the three or more processed signals.

According to an embodiment, the decorrelation module 110 may, e.g., be configured to generate the processed signals, such that a number of the processed signals being generated by the decorrelation module 110 corresponds to a number of the second audio signals minus 1, being generated by the mixer 120.

In an embodiment, the decorrelation module 110 may, e.g., be configured to generate four processed signals as the two or more processed signals. The mixer 120 may, e.g., be configured to generate five second audio signals as the two or more second audio signals from the four processed signals.

According to an embodiment, the mixer 120 may, e.g., be configured to conduct the mixing by summing samples or weighted samples of the two or more processed signals for same time indexes and/or for same points-in-time.

In an embodiment, the mixer 120 may, e.g., be configured to conduct the mixing by applying a weight to a sample for a time index or for a point-in-time of each of the two or more processed signals to obtain a weighted sample for the time index or for the point-in-time of each of the two or more processed signals, and by summing the weighted sample of each of the two or more processed signals for the time index or for the point-in-time.

According to an embodiment, the mixer 120 may, e.g., be configured to generate at least one of the second audio signals depending on at least one of the following formulae:

$$\frac{1}{2} * {x}_{orig} ( n ) + \frac{1}{2} * {x}_{D 0 , proc} ( n ) + \frac{1}{\sqrt{2}} * {x}_{D 1 , proc} ( n ) ,$$

$$\frac{1}{2} * {x}_{orig} ( n ) - \frac{1}{2} * {x}_{D 0 , proc} ( n ) + \frac{1}{\sqrt{2}} * {x}_{D 2 , proc} ( n ) ,$$

$$\frac{1}{2} * {x}_{orig} ( n ) - \frac{1}{2} * {x}_{D 0 , proc} ( n ) - \frac{1}{\sqrt{2}} * {x}_{D 2 , proc} ( n ) ,$$

$$\frac{1}{2 \sqrt{2}} * {x}_{orig} ( n ) + \frac{1}{2 \sqrt{2}} * {x}_{D 0 , proc} ( n ) - \frac{1}{2} * {x}_{D 1 , proc} ( n ) + \frac{1}{\sqrt{2}} * {x}_{D 3 , proc} ( n ) ,$$

$$\frac{1}{2 \sqrt{2}} * {x}_{orig} ( n ) + \frac{1}{2 \sqrt{2}} * {x}_{D 0 , proc} ( n ) - \frac{1}{2} * {x}_{D 1 , proc} ( n ) + \frac{1}{\sqrt{2}} * {x}_{D 3 , proc} ( n ) ,$$

wherein x_{orig}(n) indicates the first audio signal, and wherein each of x_{D0,proc}(n), x_{D1,proc}(n), x_{D2,proc}(n), x_{D3,proc}(n) indicates one of the processed signals, wherein n indicates a time index.

In an embodiment, the above-described mixes of an original signal (e.g., the first audio signal) and decorrelated signals (e.g., processed signals) may, e.g., be additionally adapted to the width (+−γ) to be modelled. The original signal x_{orig}(n) is weighted by a factor (180°−γ)/180°+1 and all decorrelated signals x_{D . . . ,proc}(n) are weighted by a factor γ/180°. This causes the mix to be x_{orig}(n) for γ=0° and gradually changing to a fully decorrelated mix for γ=180°.

According to an embodiment, the mixer 120 may, e.g., be configured to generate at least one of the second audio signals depending on at least one of the following formulae:

$$( \frac{180 ° - γ}{180 °} + 1 ) \frac{1}{2} * {x}_{orig} ( n ) + \frac{γ}{180 °} \frac{1}{2} * {x}_{D 0 , proc} ( n ) + \frac{γ}{180 °} \frac{1}{\sqrt{2}} * {x}_{D 1 , proc} ( n ) ,$$

$$( \frac{180 ° - γ}{180 °} + 1 ) \frac{1}{2} * {x}_{orig} ( n ) - \frac{γ}{180 °} \frac{1}{2} * {x}_{D 0 , proc} ( n ) + \frac{γ}{180 °} \frac{1}{\sqrt{2}} * {x}_{D 2 , proc} ( n ) ,$$

$$( \frac{180 ° - γ}{180 °} + 1 ) \frac{1}{2} * {x}_{orig} ( n ) - \frac{γ}{180 °} \frac{1}{2} * {x}_{D 0 , proc} ( n ) - \frac{γ}{180 °} \frac{1}{\sqrt{2}} * {x}_{D 2 , proc} ( n ) ,$$

$$( \frac{180 ° - γ}{180 °} + 1 ) \frac{1}{2 \sqrt{2}} * {x}_{orig} ( n ) + \frac{γ}{180 °} \frac{1}{2 \sqrt{2}} * {x}_{D 0 , proc} ( n ) - \frac{γ}{180 °} \frac{1}{2} * {x}_{D 1 , proc} ( n ) + \frac{γ}{180 °} \frac{1}{2} * {x}_{D 3 , proc} ( n ) ,$$

$$( \frac{180 ° - γ}{180 °} + 1 ) \frac{1}{2 \sqrt{2}} * {x}_{orig} ( n ) + \frac{γ}{180 °} \frac{1}{2 \sqrt{2}} * {x}_{D 0 , proc} ( n ) - \frac{γ}{180 °} \frac{1}{2} * {x}_{D 1 , proc} ( n ) + \frac{γ}{180 °} \frac{1}{\sqrt{2}} * {x}_{D 3 , proc} ( n ) ,$$

wherein x_{orig}(n) indicates the first audio signal, and wherein each of x_{D0,proc}(n), x_{D1,proc}(n), x_{D2,proc}(n), x_{D3,proc}(n) indicates one of the processed signals, wherein n indicates a time index.

In an embodiment, the mixer 120 may, e.g., be configured to use the first audio signal for obtaining the processed signal instead of the mixing, if the first audio signal comprises a transient.

According to an embodiment, the decorrelation module 110 may, e.g., be configured employ overlapping transform windows for transforming time-domain samples of the first audio signal to the frequency domain to obtain a frame of frequency bins of the transformed audio signal, and the mixer 120 may, e.g., be configured to employ in the mixing a block of time-domain samples resulting from the inverse transform of each of the two or more processed signals, to obtain a block of time-domain samples for a second audio signal of the two or more second audio signals. The apparatus may, e.g., be configured to overlap-add subsequent blocks of time-domain samples for said second audio signal of the two or more second audio signals to obtain overlap-added time domain samples of said second audio signal.

In an embodiment, if one of the overlapping transform windows comprises a transient, the mixer 120 may, e.g., be configured to use samples of the first audio signal for a corresponding block of time-domain samples for said second audio signal of the two or more second audio signals instead of the mixing.

According to an embodiment, the decorrelation module 110 may, e.g., be configured to determine, if a current frame of frequency bins of the transformed audio signal comprises a transient by determining if an energy of the frequency bins in the current frame compared to an energy of the frequency bins in a previous frame is greater than a threshold value.

In an embodiment, the apparatus achieves a smoothing of transient processing and non-transient processing by overlap-adding a first block of time-domain samples for said second audio signal of the two or more second audio signals and a second block of time-domain samples for said second audio signal, wherein the first block comprises time-domain samples of the first audio signal, in which a transient is present, and wherein the second block results from the mixing, and a transient is not present a portion of the first audio signal corresponding to the second block.

According to an embodiment, the mixer 120 may, e.g., be configured to determine said second audio signal of the two or more second audio signals for each of the two or more helper source positions in a first way, if a value of a hold variable (e.g., a hold counter) is in a first state. The mixer 120 may, e.g., be configured to determine said second audio signal for each of the two or more helper source positions in a second way, if the value of the hold variable (e.g., a hold counter) is in a first state. The value of the hold variable depends on whether a transient is present in the first audio signal.

In an embodiment, the decorrelation module 110 employs a common processing part comprising at least one of a discrete Fourier transformation, a predelay introduction and a transient handling employed equally for generating each of the two or more processed signals, wherein generating the two or more processed signals differ in at least one of dedicated allpass filters and/or filter coefficients of the dedicated allpass filters, envelope shaping and an inverse discrete Fourier transformation.

According to an embodiment, the apparatus comprises a renderer. Each of the two or more second audio signals is associated with a helper source of two or more helper sources, which exhibits a helper source position. The renderer may, e.g., be configured to generate two or more loudspeaker signals depending on the helper source position of at least one helper source of the two or more helper sources.

In an embodiment, the renderer may, e.g., be configured to generate at least two loudspeaker signals of the two or more loudspeaker signals by panning at least one of the two or more second audio signals on the at least two loudspeaker signals.

According to an embodiment, the first audio signal may, e.g., be an audio signal of a spatially extended sound source. The helper source position of each of the two or more helper sources depends on a width of the spatially extended sound source.

In an embodiment, the apparatus may, e.g., be configured to determine the two or more helper source positions depending on a width the spatially extended sound source.

According to an embodiment, the apparatus may, e.g., be configured to determine three or more helper source positions such that each such that each two neighboured helper source positions of the three or more helper source positions enclose a same azimuth angle with respect to a listener position.

In an embodiment, the mixer 120 may, e.g., be configured to generate five second audio signals for five helper sources at five helper source positions.

According to an embodiment, an azimuth angle of a middle helper source of the five helper sources corresponds to an azimuth angle of the spatially extended sound source.

In an embodiment, an elevation angle of each of the five helper sources corresponds to an elevation angle of the spatially extended sound source.

In the following, particular embodiments of the present invention are provided.

For rendering SESS in the MPEG-I renderer, the rendering engine detects the acoustically effective source extent (e.g. after occlusion) of SESS by ray tracing in the DiscoverSESS stage to determine ‘audible sectors’ and their associated transmission weights. These audible sectors and weights are then translated by a mapping function into locations and weights of a few substitute sound sources (‘helper-sources’) that together cover the intended spatial range. The substitute sources are fed with decorrelated signals obtained through a set of mutually orthogonal decorrelators. The set of decorrelators are an extension of the existing MPEG-I SESS decorrelator design. The decorrelators are combined in a tree-like structure that is adapted to the geometric positions of the helper sources.

A maximum of five sources are enough to cover the worst case (i.e. rendering of a 360 deg sound image entirely surrounding the listener) with sufficient quality.

To determine appropriate positions for the five helper sources for each extended source, its ray hits are sorted by azimuth and the largest gap between two azimuth angles is found (considering that the angles wrap around after 360 degrees). All directions except that gap are considered the apparent horizontal extent of the extended source. The elevation of the helper sources is taken from the position of the extended source as given in the bitstream, relative to the listener position.

In the following, particular application examples of embodiments are described.

In particular, a homogeneous extent rendering level (Level 3) is provided.

For binaural rendering, the DiscoverSESS stage uses ray directions that are translated and rotated in unison with the tracked listener translation and rotation. For loudspeaker rendering, the behavior is switched to only follow the translation of the listener. The rotation of the listener has no effect on the ray directions.

Now, the Rendering Process according to embodiments is described.

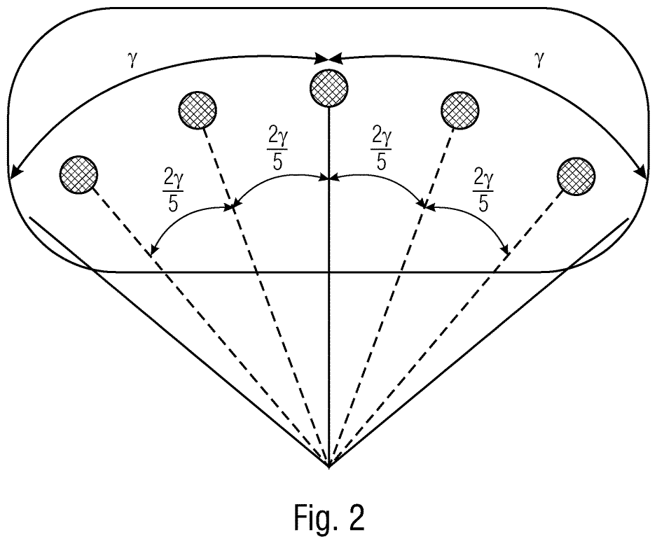

To determine appropriate positions for the five helper sources for each extended source, its ray hits are sorted by azimuth and the largest gap between two azimuth angles is found (considering that the angles wrap around after 360 degrees). All directions except that gap are considered the apparent horizontal extent of the extended source. Within the width (+/−γ) of the extended object, five objects are equally distributed as illustrated in FIG. 2.

In particular, FIG. 2 illustrates a scenario where within the width (+−γ) of the extended object, five objects are equally distributed.

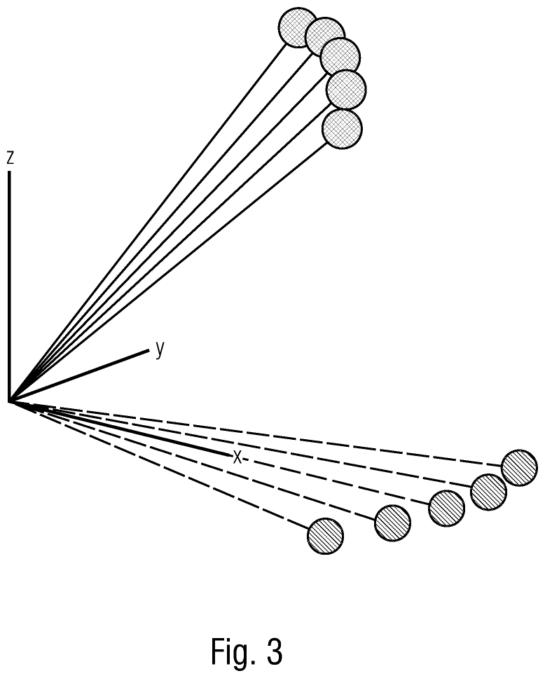

The elevation of the helper sources is taken from the position of the extended source as given in the bitstream, relative to the listener position. The five objects are rotated such that the middle object has the same azimuth and elevation as the extended object. This is shown in FIG. 3.

In particular, FIG. 3 illustrates five objects, which are rotated such that the middle object has the same azimuth and elevation as the extended object.

For each of the five helper sources, all ray hits closest to their position are collected, leading to five groups of ray hits. For each of the five groups, a new render item is generated using decorrelated signals as input signal and with the average EQs and weights of all ray hits in the group. The original render items are deactivated. The new render items representing the five helper sources per extended source are then rendered like object sources as described in Level 2.

In the following, helper source generation according to embodiments is described.

To obtain the signals of the five helper sources, four instances of the decorrelator, e.g., the decorrelator described in the working draft (see annex of this document for an excerpt), are calculated with different filter parameters to generate mutually decorrelated outputs. For computational efficiency, all decorrelators share a common processing part (DFT, predelay, transient handling) and just differ in dedicated allpass filters, envelope shaping and IDFT transform.

The filter parameters a₁=b₀ of each series of first order all-pass filters are listed in the following for each stage apᵢ for i=1, 2, 3, 4.:

$${D}_{0} = \{ 3.425237153366657 e - 01 , 3.275585702587662 e - 01 , - 6.015992663486394 e - 01 , - 52020935196035589 e - 01 \}$$

$${D}_{1} = \{ - 1.266480615654806 e - 01 , - 6.485588771813453 e - 01 , 4.9609579713951515 e - 01 , 3.8810355506542455 e - 01 \}$$

$${D}_{2} = \{ 5.505005711289418 e - 01 , 2.8687006565308293 e - 01 , 3.8631088684732218 e - 01 , - 47691492335083735 e - 01 \}$$

$${D}_{3} = \{ - 6.170403656014813 e - 01 , - 4.627137757181171 e - 01 , 4.860440129117042 e - 01 , 6.529273261580918 e - 01 \}$$

From these four decorrelator outputs, the five helper sources M, LL, RR, L, R are derived by combinations of the original point source signal and various decorrelator outputs. This processing replaces the mixer stage as described in the MPEG-I decorrelators.

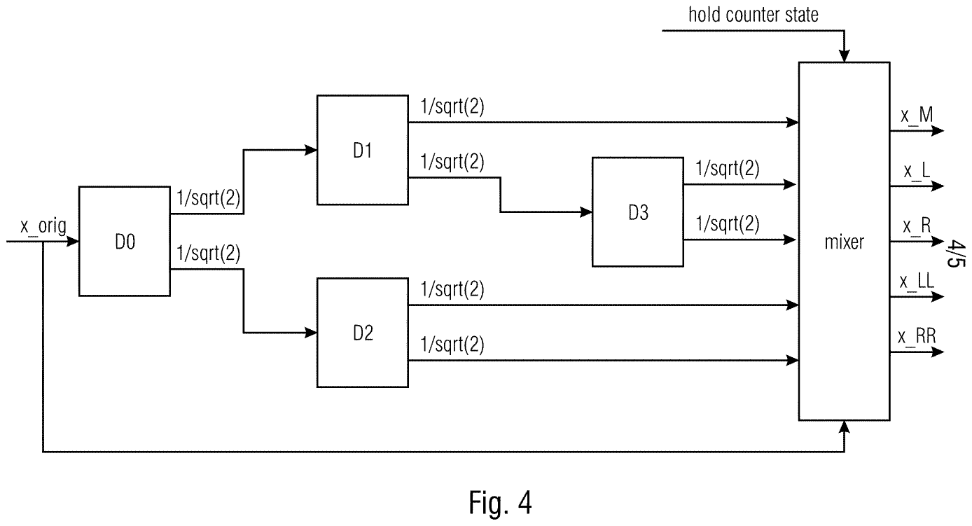

FIG. 4 illustrates a decorrelator tree structure according to an embodiment. The mixing equations define the outputs of a cascaded tree of four 2-channel decorrelators as depicted in FIG. 4.

The tree structure is adapted to the spatial positions of the helper sources:
x_M is the central helper source
x_L and x_R is the inner helper source pair
   X_LL and x_RR is the outer helper source pair
Helper source pairs share contributions of the same decorrelators
Helper source pairs are the two outputs from one common decorrelator that is placed last in the tree hierarchy

In ff., five mixing equations are derived from the underlying tree structure.

$${x}_{M , out} ( n ) = \{ \begin{matrix}\begin{matrix}\frac{1}{2} * {x}_{orig} ( n ) + \frac{1}{2} * \\ {x}_{D 0 , proc} ( n ) + \frac{1}{\sqrt{2}} * {x}_{D 1 , proc} ( n )\end{matrix} & , if hold counter inactive \\ {x}_{orig} ( n ) & , if hold counter active\end{matrix} \qquad ( 1 )$$

$${x}_{L L , o u t} ( n ) = \{ \begin{matrix}\begin{matrix}\frac{1}{2} * {x}_{orig} ( n ) - \frac{1}{2} * \\ {x}_{D 0 , proc} ( n ) + \frac{1}{\sqrt{2}} * {x}_{D 2 , proc} ( n )\end{matrix} & , if hold counter inactive \\ {x}_{orig} ( n ) & , if hold counter active\end{matrix} \qquad ( 2 )$$

$${x}_{R R , o u t} ( n ) = \{ \begin{matrix}\begin{matrix}\frac{1}{2} * {x}_{orig} ( n ) - \frac{1}{2} * \\ {x}_{D 0 , proc} ( n ) - \frac{1}{\sqrt{2}} * {x}_{D 2 , proc} ( n )\end{matrix} & , if hold counter inactive \\ {x}_{orig} ( n ) & , if hold counter active\end{matrix} \qquad ( 3 )$$

$${x}_{L , o u t} ( n ) = \{ \begin{matrix}\begin{matrix}\frac{1}{2 \sqrt{2}} * {x}_{orig} ( n ) + \frac{1}{2 \sqrt{2}} * {x}_{D 0 , proc} ( n ) - \\ \frac{1}{2} * {x}_{D 1 , proc} ( n ) + \frac{1}{\sqrt{2}} * {x}_{D 3 , proc} ( n )\end{matrix} & , if hold counter inactive \\ {x}_{orig} ( n ) & , if hold counter active\end{matrix} \qquad ( 4 )$$

$${x}_{R , o u t} ( n ) = \{ \begin{matrix}\begin{matrix}\frac{1}{2 \sqrt{2}} * {x}_{orig} ( n ) + \frac{1}{2 \sqrt{2}} * {x}_{D 0 , proc} ( n ) - \\ \frac{1}{2} * {x}_{D 1 , proc} ( n ) - \frac{1}{\sqrt{2}} * {x}_{D 3 , proc} ( n )\end{matrix} & if hold counter inactive \\ {x}_{orig} ( n ) & , if hold counter active\end{matrix} \qquad ( 5 )$$

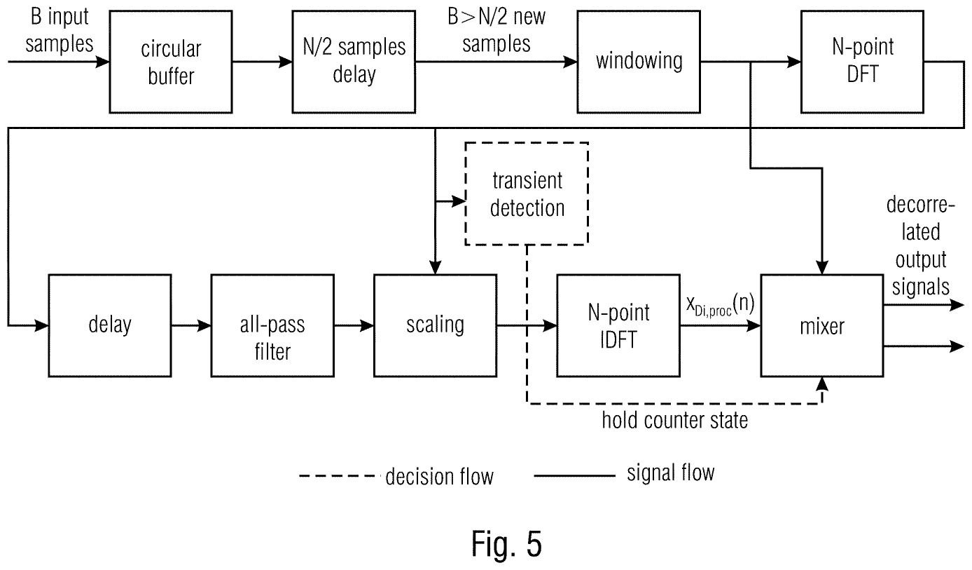

FIG. 5 illustrates an MPEG-I decorrelator according to an embodiment. B input samples of an audio input signal are fed into the MPEG-I decorrelator. In the MPEG-I decorrelator, the input samples are received by a circular buffer, an N/2 samples delay is introduced, and windowing is conducted. The signal is then N-point-DFT transformed, a pre-delay is introduced, all-pass-filters are applied, scaling is conducted and the resulting signal is inversely transformed by an N-point IDFT to obtain a processed signal.

In some embodiments, the processed signal from the MPEG-I decorrelator is then used when the above mixing equations are applied.

Signal x_{D0,proc}(n) may, e.g., be the processed signal resulting from the output of the N-point IDFT of decorrelator instance Do; x_{D1,proc}(n) may, e.g., be the processed signal resulting from the output of the N-point IDFT of decorrelator instance D₁; x_{D2,proc}(n) may, e.g., be the processed signal resulting from the output of the N-point IDFT of decorrelator instance D₂; and x_{D3,proc}(n) may, e.g., be the processed signal resulting from the output of the N-point IDFT of decorrelator instance D₃, e.g., of an MPEG-I or MPEG-I-like decorrelator.

In some embodiments, however, the mixer stage of the MPEG-I decorrelator is not used, but mixing according to embodiments is employed, e.g., the mixing equations defined above.

By the above mixing equations, five audio signals for five helper sources/helper source positions are obtained.

According to an embodiment, the audio signals of the helper sources at the virtual positions of the helper sources may, e.g., be panned (by applying a panning algorithm, for example, amplitude panning) to obtain two or more loudspeaker signals for two or more loudspeakers at two or more loudspeaker positions.

The MPEG-I decorrelator, which may, e.g., be employed, for example, except of its mixer, by some embodiments, is described in the following.

[ . . . ] The input mono signal is first fed into the decorrelator to obtain two decorrelated versions.

The MPEG-I decorrelator performs the following steps to create two completely decorrelated signals from one. FIG. 5 is the block diagram of the decorrelator. The decorrelator has an internal processing cycle of a fixed number of 256 samples regardless of the global block size B, so a circular buffer is used to manage the reading and writing of samples in to the decorrelator. The incoming B samples of the renderer are written into the internal buffer. The write cursor starts 128 samples ahead of the read cursor, which acts as a delay compensation unit that is parallel to the whole processing chain. There is a 128-sample of overlap between each decorrelator processing frame. As a consequence, when more than 128 new samples come in, N samples (128 old+128 new) are stored in the input buffer and the decorrelation processing starts.

A 256-point DFT is performed on the windowed frame to obtain K=129 frequency bins. A sine window is applied as shown in equation (228), where N=256.

$${x}_{w i n} ( n ) = x ( n ) * sin ( ( n + 0.5 ) * π / N ) \qquad ( 228 )$$

The complex DFT coefficients are passed through a delay, as illustrated in Equation (229) for the n-th frame, where Da is the pre-delay. The pre-delay is set to 4 frames. Next, the delayed signal is passed on to a series of first order all-pass filters, which is illustrated in direct form I in Equation (230), where a₁=b₀=0.7 and b₁=1 represent the coefficients, and Dap; represents the amount of delay of each all-pass filter, which is 1, 2, 3, 5 frames for i=1, 2, 3, 4. In the following steps, X (n) is called the direct component (DC), while Y(n), which went through the delay and all-pass filter, is called the processed component (PC).

$$Y ( n ) = X ( n - {D}_{d} ) \qquad ( 229 )$$

$$Y ( n ) = {b}_{0} X ( n ) + {b}_{1} X ( n - {D}_{api} ) - {a}_{1} Y ( n - {D}_{api} ) \qquad ( 230 )$$

A transient in the current frame is detected by calculating whether the energy of the current frame, summed over certain frequency bins, is stronger than the previous frame by a threshold T=2.8. Two counters control the transient processing: a hold counter and a inhibition counter. Both are initially set to their inactive state 0. When a transient is detected and the inhibition counter is inactive, a hold counter is started for the next 8 frames to control a muting of the processed signal in the output mix. Also, the inhibition counter starts counting to prevent a hold counter start in the next 56 frames. In addition, if another transient is detected during this inhibition time, this will re-start the inhibition counter, and the inhibition time will be increase from 56 to 64 frames. When active counters reach their maximum count, they are reset to their inactive state 0.

The energy in current frame is calculated using the DCs. The energy of the current frame is smoothed by a factor of δ=0.4 with the previous frame. Equation (231) and (232) illustrates how energy of the current frame, E(n), is calculated with the energy of the previous frame, E(n−1), and the DCs, Xₖ(n), and how the decision of transient detection is made respectively.

$$E ( n ) = δ * ( {\sum }_{k = 4}^{K} {{X}_{k} ( n )}^{2} ) + ( 1 - δ ) * E ( n - 1 ) \qquad ( 231 )$$

$$\{ \begin{matrix}transient detected & , if E ( n ) > T * E ( n - 1 ) \\ no transient detected & , otherwise\end{matrix} \qquad ( 232 )$$

Each bin of the PCs is amplified or attenuated if it is weaker or stronger by a factor of β=1.5 comparing to the DC. Equation (233) and (234) illustrates how to calculate the energy of the current PC, E_{p,k}(n), and the current DC, E_{d,k}(n) with α=0.4. Equation (235) demonstrates the boosting or suppression process depending on the energy difference. Finally, the PC is multiplied with a fixed normalized factor f=1.1.

$${E}_{p , k} ( n ) = α * {{Y}_{k} ( n )}^{2} + ( 1 - α ) * {E}_{p , k} ( n - 1 ) \qquad ( 233 )$$

$${E}_{d , k} ( n ) = α * {{X}_{k} ( n )}^{2} + ( 1 - α ) * {E}_{d , k} ( n - 1 ) \qquad ( 234 )$$

$$Y ( n ) = \{ \begin{matrix}f * Y ( n ) * \sqrt{\frac{β * {E}_{d , k} ( n )}{{E}_{p , k} ( n )}} & , if {E}_{p , k} ( n ) > β * {E}_{d , k} ( n ) \\ f * Y ( n ) * \sqrt{\frac{{E}_{d , k} ( n )}{β * {E}_{p , k} ( n )}} & , if {E}_{p , k} ( n ) > β * {E}_{d , k} ( n ) \\ f * Y ( n ) & , otherwise\end{matrix} . \qquad ( 235 )$$

A N-point IDFT is performed to transform the processed frequency bins to time domain and frames are combined in a windowed overlap-add procedure applying a sine window.

The decorrelated output with normalization is generated as illustrated in Equation (236). If the hold counter is inactive, the two decorrelated output frames are the sum and the difference of the windowed and original input and the processed signal respectively. If a transient was detected and the hold counter is activated, the two output frames will be identical, and contain the windowed and original input weighted by a scaling factor.

$${x}_{o u t} ( n ) = \{ \begin{matrix}{x}_{orig} ( n ) \pm {x}_{proc} ( n ) & , if hold counter inactive \\ 2 / \sqrt{2} * {x}_{orig} ( n ) & , if hold counter active\end{matrix} \qquad ( 236 )$$

The writing of 128 samples from the decorrelator output and the reading of B samples back to the renderer input for the two decorrelated signals are managed using circular buffers. [ . . . ]

A rendering algorithm according to an embodiment may be implemented as follows:

### Initialization:

$$v oid homextobjs\_init ( homextobjs\_pr \_t ⋆ params \text{/*} out : internal params * / )$$

$$\{ params -> nobj = 5 ; / * number of objects used for one extended object * / params -> warp = 1. f ; / * extended object width warping * / \}$$

### Computation of Helper Objects:

void homextobjs_process(
homextobjs_pr_t *params, /* in: parameters */

| | | |
|---|---|---|
| float | azi, /* in: | azimuth of object [deg] */ |
| float | ele, /* in: | elevation of object [deg] */ |
| float | width, /* in: | with of object = +−width [deg] */ |
| float | objazis[ ], /* out: | nobj object azimuths */ |
| float | objeles[ ] /* out: | nobj object elevations */ |
| ) | | |

```
{
  int i;
  float first, sector;
  /* warp width */
  width = fminf(width, 180.0f);
  width = fmaxf(width, 0.0f);
  width = powf(width / 180.0f, params−>warp) * 180.0f;
  sector = 2.0f * width / params−>nobj;
  first = − width + 0.5f*sector;
  for (i = 0; i < params−>nobj; i++) {
    float angle;
    /* compute object angle as if dir and ele would be zero */
    angle = first + i*sector;
    /* compute azi/ele considering object elevation (rotate around y axis) */
        objazis[i] =
      180.0f/M_PI*atan2f(sinf(angle*M_PI/180.0f), cos(ele*M_PI/180)*cosf(angle*
      M_PI/180));
          objeles[i] =
      180.0f/M_PI*asinf(sinf(ele*M_PI/180.0f)*cosf(angle*M_PI/180.0f));
    /* consider oject azimuth */
    objazis[i] += azi;
    /* unwrap */
    while (objazis[i] > 180.0f) objazis[i] −= 360.0f;
    while (objazis[i] <= −180.0f) objazis[i] += 360.0f;
  }
}
```

In the following, a computation of average EQs and weights for helper source RIs according to embodiments is described.

For each helper source RI numbered i=[1,2,3,4,5], the closest ray hits are collected and their EQs are averaged and assigned to the helper source RI. The average EQ coefficient f_{i,j} for each band j is calculated by

$${f}_{i , j} = \sqrt{\frac{{\sum }_{k} {w}_{k} {c}_{k , j}^{2}}{{N}_{total}}} ,$$

where wₖ is the weight of a ray hit k and c_{k,j} is the coefficient of band j based on the occlusion of this ray. Nₜₒₜₐₗ is the total number of ray hits for the whole extended source.

For each helper source RI numbered i=[1,2,3,4,5], the distances of all corresponding ray hits are averaged. These average distances di are used to calculate additional weighting factors fᵢ with for each of the five helper source RIs.

$${f}_{i} = \frac{\sqrt{{d}_{1}^{2} + {d}_{2}^{2} + {d}_{3}^{2} + {d}_{4}^{2} + {d}_{5}^{2}}}{{d}_{i}}$$

In the following, further embodiments are provided:

An/a apparatus/method for decorrelation of an audio signal
Decorrelator, including one or more or all of the following:
Dedicated tree structure adapted to helper source geometry
Mixing equations according to tree structure
Transient handling within tree structure
Shared use of decorrelator front-end for all decorrelators: for computational efficiency, all decorrelators share a common front-end consisting of DFT, transient detection, direct sound energy estimation and pre-delay.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] W. Oomen, E. Schuijers, B. den Brinker, and J. Breebaart, “Advances in Parametric Coding for High-Quality Audio,” Paper 5852 March 2003.
[2] J. Breebaart, S. van de Par, A. Kohlrausch, and E. Schuijers, “High-quality Parametric Spatial Audio Coding at Low Bitrates,” Paper 6072 May 2004.
[3] H. Purnhagen, J. Engdegard, J. Roden, and L. Liljeryd, “Synthetic Ambience in Parametric Stereo Coding,” Paper 6074 May 2004.
[4] J. Herre, K. Kjorling, J. Breebaart, C. Faller, S. Disch, H. Purnhagen, J. Koppens, J. Hilpert, J. Rödén, W. Oomen, K. Linzmeier, and KO. SE. Chong, “MPEG Surround—The ISO/MPEG Standard for Efficient and Compatible Multichannel Audio Coding,” J. Audio Eng. Soc., vol. 56, no. 11, pp. 932-955, November 2008.
[5] S. Disch, “Decorrelation for immersive audio applications and sound effects,” in Proc. DAFx-23, Copenhagen, Denmark, September 2023.

1. An apparatus for processing a first audio signal to generate two or more second audio signals, wherein the apparatus comprises:
a decorrelation module configured for generating two or more processed signals from the first audio signal, wherein the decorrelation module is configured to generate each processed signal of the two or more processed signals by transforming the first audio signal to a frequency domain to acquire a transformed audio signal, by applying a delay, by applying allpass filters on the transformed audio signal, by conducting envelope shaping and by conducting an inverse transform to acquire the processed signal, and
a mixer configured for generating each second audio signal of the two or more second audio signals by conducting a mixing of at least two processed signals of the two or more processed signals,
wherein the decorrelation module is configured to apply the allpass filters using different filter coefficients for generating each of the two or more processed signals, and
wherein the mixer is configured to conduct the mixing in a different way for generating each of the two or more second audio signals.

2. An apparatus according to claim 1,
wherein the mixer is configured to generate each second audio signal of the two or more second audio signals by conducting a mixing of the at least two processed signals and of the first audio signal.

3. An apparatus according to claim 2,
wherein the mixer is configured to conduct the mixing of the at least two processed signals and of the first audio signal by applying a first weighting factor on the first audio signal, by applying a second weighting factor on each of the at least two processed signals and by combining the first audio signal after an application of the first weighting factor and the at least two processed signals after an application of the second weighting factor on each of the at least two processed signals.

4. An apparatus according to claim 3,
wherein the mixer is configured to apply a same second weighting factor on each of the at least two processed signals.

5. An apparatus according to claim 3,
wherein the first and/or the second weighting factor depends a width of a spatially extended sound source which shall be modelled.

6. An apparatus according to claim 5,
wherein the mixer is configured to apply
$$\frac{180 ° - γ}{180 °} + 1$$
as the first weighting factor on the first audio signal, and
wherein the mixer is configured to apply
$$\frac{γ}{180 °}$$
as the second weighting factor on each of the at least two processed audio signals,
wherein γ is an angular value which depends on the width of the spatially extended sound source, which shall be modeled.

7. An apparatus according to claim 1,
wherein the decorrelation module is configured to generate three or more processed signals,
wherein the mixer is configured for generate at least one second audio signal of the two or more second audio signals by conducting a mixing of at least three processed signals of the three or more processed signals.

8. An apparatus according to claim 1,
wherein the decorrelation module is configured to generate the processed signals, such that a number of the processed signals being generated by the decorrelation module corresponds to a number of the second audio signals minus 1, being generated by the mixer.

9. An apparatus according to claim 8,
wherein the decorrelation module is configured to generate four processed signals as the two or more processed signals, and
wherein the mixer is configured to generate five second audio signals as the two or more second audio signals from the four processed signals.

10. An apparatus according to claim 1,
wherein the mixer is configured to conduct the mixing by summing samples or weighted samples of the two or more processed signals for same time indexes and/or for same points-in-time.

11. An apparatus according to claim 1,
wherein the mixer is configured to conduct the mixing by applying a weight to a sample for a time index or for a point-in-time of each of the two or more processed signals to acquire a weighted sample for the time index or for the point-in-time of each of the two or more processed signals, and by summing the weighted sample of each of the two or more processed signals for the time index or for the point-in-time.

12. An apparatus according to claim 1,
wherein the mixer is configured to generate at least one of the second audio signals depending on at least one of the following formulae:
$$\frac{1}{2} * {x}_{o r i g} ( n ) + \frac{1}{2} * {x}_{D 0 , p r o c} ( n ) + \frac{1}{\sqrt{2}} * {x}_{D 1 , p r o c} ( n ) ,$$
$$\frac{1}{2} * {x}_{o r i g} ( n ) - \frac{1}{2} * {x}_{D 0 , p r o c} ( n ) + \frac{1}{\sqrt{2}} * {x}_{D 2 , p r o c} ( n ) ,$$
$$\frac{1}{2} * {x}_{o r i g} ( n ) - \frac{1}{2} * {x}_{D 0 , p r o c} ( n ) - \frac{1}{\sqrt{2}} * {x}_{D 2 , p r o c} ( n ) ,$$
$$\frac{1}{2 \sqrt{2}} * {x}_{o r i g} ( n ) + \frac{1}{2 \sqrt{2}} * {x}_{D 0 , p r o c} ( n ) - \frac{1}{2} * {x}_{D 1 , p r o c} ( n ) + \frac{1}{\sqrt{2}} * {x}_{D 3 , p r o c} ( n ) ,$$
$$\frac{1}{2 \sqrt{2}} * {x}_{o r i g} ( n ) + \frac{1}{2 \sqrt{2}} * {x}_{D 0 , p r o c} ( n ) - \frac{1}{2} * {x}_{D 1 , p r o c} ( n ) + \frac{1}{\sqrt{2}} * {x}_{D 3 , p r o c} ( n ) ,$$
wherein x_{orig}(n) indicates the first audio signal, and
wherein each of x_{D0,proc}(n), X_{D1,proc}(n), X_{D2,proc}(n), X_{D3,proc}(n) indicates one of the processed signals,
wherein n indicates a time index.

13. An apparatus according to claim 1,
wherein the mixer is configured to apply
$$\frac{180 ° - γ}{180 °} + 1$$
as the first weighting factor on the first audio signal, and
wherein the mixer is configured to apply
$$\frac{γ}{180 °}$$
as the second weighting factor on each of the at least two processed audio signals,
wherein γ is an angular value which depends on the width of the spatially extended sound source, which shall be modeled,
wherein the mixer is configured to generate at least one of the second audio signals depending on at least one of the following formulae:
$$( \frac{180 ° - γ}{180 °} + 1 ) \frac{1}{2} * {x}_{o r i g} ( n ) + \frac{γ}{180 °} \frac{1}{2} * {x}_{D 0 , p r o c} ( n ) + \frac{γ}{180 °} \frac{1}{\sqrt{2}} * {x}_{D 1 , p r o c} ( n ) ,$$
$$( \frac{180 ° - γ}{180 °} + 1 ) \frac{1}{2} * {x}_{o r i g} ( n ) - \frac{γ}{180 °} \frac{1}{2} * {x}_{D 0 , p r o c} ( n ) + \frac{γ}{180 °} \frac{1}{\sqrt{2}} * {x}_{D 2 , p r o c} ( n ) ,$$
$$( \frac{180 ° - γ}{180 °} + 1 ) \frac{1}{2} * {x}_{o r i g} ( n ) - \frac{γ}{180 °} \frac{1}{2} * {x}_{D 0 , p r o c} ( n ) - \frac{γ}{180 °} \frac{1}{\sqrt{2}} * {x}_{D 2 , p r o c} ( n ) ,$$
$$( \frac{180 ° - γ}{180 °} + 1 ) \frac{1}{2 \sqrt{2}} * {x}_{o r i g} ( n ) + \frac{γ}{180 °} \frac{1}{2 \sqrt{2}} * {x}_{D 0 , p r o c} ( n ) - \frac{γ}{180 °} \frac{1}{2} * {x}_{D 1 , p r o c} ( n ) + \frac{γ}{180 °} \frac{1}{\sqrt{2}} * {x}_{D 3 , p r o c} ( n ) ,$$
$$( \frac{180 ° - γ}{180 °} + 1 ) \frac{1}{2 \sqrt{2}} * {x}_{o r i g} ( n ) + \frac{γ}{180 °} \frac{1}{2 \sqrt{2}} * {x}_{D 0 , p r o c} ( n ) - \frac{γ}{180 °} \frac{1}{2} * {x}_{D 1 , p r o c} ( n ) + \frac{γ}{180 °} \frac{1}{\sqrt{2}} * {x}_{D 3 , p r o c} ( n ) ,$$
wherein x_{orig}(n) indicates the first audio signal, and
wherein each of X_{D0,proc}(n), X_{D1,proc}(n), X_{D2,proc}(n), X_{D3,proc}(n) indicates one of the processed signals,
wherein n indicates a time index.

14. An apparatus according to claim 1,
wherein the mixer is configured to use the first audio signal for acquiring the processed signal instead of the mixing, if the first audio signal comprises a transient.

15. An apparatus according to claim 1,
wherein the decorrelation module is configured employ overlapping transform windows for transforming time-domain samples of the first audio signal to the frequency domain to acquire a frame of frequency bins of the transformed audio signal, and the mixer is configured to employ in the mixing a block of time-domain samples resulting from the inverse transform of each of the two or more processed signals, to acquire a block of time-domain samples for a second audio signal of the two or more second audio signals, and
wherein the apparatus is configured to overlap-add subsequent blocks of time-domain samples for said second audio signal of the two or more second audio signals to acquire overlap-added time domain samples of said second audio signal.

16. An apparatus according to claim 15,
wherein, if one of the overlapping transform windows comprises a transient, the mixer is configured to use samples of the first audio signal for a corresponding block of time-domain samples for said second audio signal of the two or more second audio signals instead of the mixing.

17. An apparatus according to claim 15,
wherein the decorrelation module is configured to determine, if a current frame of frequency bins of the transformed audio signal comprises a transient by determining if an energy of the frequency bins in the current frame compared to an energy of the frequency bins in a previous frame is greater than a threshold value.

18. An apparatus according to claim 15,
wherein the apparatus achieves a smoothing of transient processing and non-transient processing by overlap-adding a first block of time-domain samples for said second audio signal of the two or more second audio signals and a second block of time-domain samples for said second audio signal, wherein the first block comprises time-domain samples of the first audio signal, in which a transient is present, and wherein the second block results from the mixing, and a transient is not present a portion of the first audio signal corresponding to the second block.

19. An apparatus according to claim 15,
wherein the mixer is configured to determine said second audio signal of the two or more second audio signals for each of the two or more helper source positions in a first way, if a value of a hold variable (e.g., a hold counter) is in a first state, and
wherein the mixer is configured to determine said second audio signal for each of the two or more helper source positions in a second way, if the value of the hold variable (e.g., a hold counter) is in a first state,
wherein the value of the hold variable depends on whether a transient is present in the first audio signal.

20. An apparatus according to claim 1,
wherein the decorrelation module employs a common processing part comprising at least one of a discrete Fourier transformation, a predelay introduction and a transient handling employed equally for generating each of the two or more processed signals, wherein generating the two or more processed signals differ in at least one of dedicated allpass filters and/or filter coefficients of the dedicated allpass filters, envelope shaping and an inverse discrete Fourier transformation.

21. An apparatus according to claim 1,
wherein the apparatus comprises a renderer,
wherein each of the two or more second audio signals is associated with a helper source of two or more helper sources, which exhibits a helper source position,
wherein the renderer is configured to generate two or more loudspeaker signals depending on the helper source position of at least one helper source of the two or more helper sources.

22. An apparatus according to claim 21,
wherein the renderer is configured to generate at least two loudspeaker signals of the two or more loudspeaker signals by panning at least one of the two or more second audio signals on the at least two loudspeaker signals.

23. An apparatus according to claim 21,
wherein the first audio signal is an audio signal of a spatially extended sound source,
wherein the helper source position of each of the two or more helper sources depends on a width of the spatially extended sound source.

24. An apparatus according to claim 23,
wherein the apparatus is configured to determine the two or more helper source positions depending on a width the spatially extended sound source.

25. An apparatus according to claim 24,
wherein the apparatus is configured to determine three or more helper source positions such that each such that each two neighboured helper source positions of the three or more helper source positions enclose a same azimuth angle with respect to a listener position.

26. An apparatus according to claim 23,
wherein the mixer is configured to generate five second audio signals for five helper sources at five helper source positions.

27. An apparatus according to claim 26,
wherein an azimuth angle of a middle helper source of the five helper sources corresponds to an azimuth angle of the spatially extended sound source.

28. An apparatus according to claim 26,
wherein an elevation angle of each of the five helper sources corresponds to an elevation angle of the spatially extended sound source.

29. A method for processing a first audio signal to generate two or more second audio signals, wherein the method comprises:
generating two or more processed signals from the first audio signal, wherein generating each processed signal of the two or more processed signals is conducted by transforming the first audio signal to a frequency domain to acquire a transformed audio signal, by applying a delay, by applying allpass filters on the transformed audio signal, by conducting envelope shaping and by conducting an inverse transform to acquire the processed signal, and
generating each second audio signal of the two or more second audio signals by conducting a mixing of at least two processed signals of the two or more processed signals,
wherein applying the allpass filters is conducted using different filter coefficients for generating each of the two or more processed signals, and
wherein the mixing is conducted in a different way for generating each of the two or more second audio signals.

30. A non-transitory digital storage medium having a computer program stored thereon to perform the method for processing a first audio signal to generate two or more second audio signals, wherein the method comprises:
generating two or more processed signals from the first audio signal, wherein generating each processed signal of the two or more processed signals is conducted by transforming the first audio signal to a frequency domain to acquire a transformed audio signal, by applying a delay, by applying allpass filters on the transformed audio signal, by conducting envelope shaping and by conducting an inverse transform to acquire the processed signal, and
generating each second audio signal of the two or more second audio signals by conducting a mixing of at least two processed signals of the two or more processed signals,
wherein applying the allpass filters is conducted using different filter coefficients for generating each of the two or more processed signals, and
wherein the mixing is conducted in a different way for generating each of the two or more second audio signals,
when said computer program is run by a computer.
